(19) United States
(12) Patent Application Publication
(10) Pub. No.: US 2026/0084089 A1
(43) Pub. Date: Mar. 26, 2026

(54) Method For Controlling A System For Separating Carbon Dioxide From Ambient Air And System

(71) Applicants: Volkswagen Aktiengesellschaft, Wolfsburg (DE); EVERLLENCE SE, Augsburg (DE)

(72) Inventors: Christian HEIMERMANN, Wolfsburg (DE); Marcel WIEGEL, Gardelegen (DE); Peter KAWELKE, Wolfsburg (DE); Martin HOFER, Braunschweig (DE); Klaus BEHNKE, Schriesheim (DE); Stephan WEBER, Herten (DE); Holger BUSCHMANN, Dinslaken (DE)

(73) Assignees: Volkswagen Aktiengesellschaft, Wolfsburg (DE); EVERLLENCE SE, Augsburg (DE)

(21) Appl. No.: 19/197,408

(22) Filed: May 2, 2025

(30) Foreign Application Priority Data
May 3, 2024 (DE) 102024112495.4

(51) Int. Cl. B01D 53/04; B01D 53/26

(52) U.S. Cl. CPC B01D 53/0454; B01D 53/0438; B01D 53/0446; B01D 53/261; B01D 2257/504; B01D 2257/80; B01D 2258/06; B01D 2259/40088

(57) ABSTRACT

The disclosure relates to a method for controlling a system for separating carbon dioxide from the ambient air. The method distinguishes between normal operation, in which carbon dioxide is separated from the ambient air, and special operation, which is not primarily used to separate carbon dioxide. Normal operation comprises conveying a stream of air of ambient air into a first process space of the system, wherein the stream of air is dried in the first process space. The dried stream of air of the ambient air is conducted from the first process space into a second process space, in which adsorption and subsequent desorption of carbon dioxide takes place. In the special operation mode, which takes place before or after normal operation, the system is operated with operating parameters that deviate from normal operation.

### CROSS-REFERENCE TO RELATED APPLICATIONS

This application claims priority to German Patent Application DE 10 2024 112 495.4, filed on May 3, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for controlling a system for separating carbon dioxide from the ambient air and to a system for carrying out such a method.

Systems and methods for capturing carbon dioxide from the ambient air are known to the inventors. Such a capture can be carried out using what is known as the “direct air capture method,” wherein the carbon dioxide can be captured directly from the ambient air, stored or fed into a further process. Carbon dioxide can be separated from the ambient air using different sorbents. Typically, chemisorbents and/or physisorbents are used to separate carbon dioxide. Amine-based chemisorbents have the problem of aging and degradation when the material comes into contact with oxygen at temperatures above approx. 60° C. This can occur during the desorption phase at temperatures of around 100° C. if countermeasures are not implemented, for example an inert atmosphere in the system using water vapor or other gases. These protective measures are laborious and expensive. Physisorbents, such as zeolites, have the problem that the affinity of the sorbent material for water (vapor) is higher than for carbon dioxide, which means that the ambient air must first be dried before being supplied to an adsorption space in which the zeolite material is arranged. Drying the air in this way is also laborious and expensive.

In addition to normal operation of the system, in which a cyclical drying process and a cyclical sorption process downstream of the drying process for adsorption and subsequent desorption of carbon dioxide take place, there are other operating modes in systems for separating carbon dioxide from the ambient air which deviate from this normal operation and for which special operating strategies may be necessary.

### SUMMARY

A need exists to improve the efficiency of a system for separating carbon dioxide in an operating state deviating from normal operation.

The need is addressed by the subject matter of the independent claim(s). Embodiments of the invention are described in the dependent claims, the following description, and the drawings.

### BRIEF DESCRIPTION OF THE DRAWINGS

FIG. 1 shows an example embodiment of a system for separating carbon dioxide from the ambient air;

FIG. 2 shows an example flow chart for controlling such a system for separating carbon dioxide from the ambient air.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for controlling a system for separating carbon dioxide from the ambient air is provided. The method may distinguish between normal operation, in which carbon dioxide is separated from the ambient air, and special operation, which is not primarily used to separate carbon dioxide.

The operation of the system for separating carbon dioxide in normal operation may in some embodiments comprise the following:
conveying a stream of air of the ambient air into a first process space, wherein the stream of air is dried in the first process space,
conducting the dried ambient air from the first process space to a second process space,
adsorbing carbon dioxide from the dried stream of air with a sorbent material in the second process space,
desorbing the carbon dioxide adsorbed in the sorbent material, and
storing the desorbed carbon dioxide in a storage unit.

In special operation, also referred herein as ‘special operation mode’, which is carried out before or after normal operation, the system is operated with operating parameters that deviate from the operating parameters of normal operation.

In this context, normal operation of the system means operation in which the system separates and stores carbon dioxide from the atmosphere at a rate of at least 50% of its rated output. In this context, special operation means in particular, but not exclusively, a start-up of the system, a switch-off or shutdown of the system, a downtime mode of the system, restricted or stopped operation after a detected malfunction.

During special operation, the system may be conditioned for normal operation, but without any significant separation of carbon dioxide from the atmosphere taking place in this special operation. The method according to the teachings herein may make it possible to achieve efficient preconditioning of the process spaces of the system during special operation, in particular to minimize water retention in the drying agent and/or the sorbent. Furthermore, the method makes it possible to increase efficiency in normal operation following special operation, since the conditions in the process spaces are already favorable for drying the air or adsorbing carbon dioxide, respectively.

The dependent claims discuss various embodiments.

In some embodiments, it is provided that the special operation comprises a start-up of the system after a system downtime. The start-up process can be used to precondition the process spaces of the system for normal operation. In particular, when the system is started up, ambient air can initially be prevented from flowing into one of the process spaces in order to facilitate such preconditioning.

For example, it is beneficial if an additional regeneration of the drying agent and/or a drying of the sorbent material takes place during the start-up of the system before the stream of air of the ambient air is introduced into a drying unit or a sorption unit of the system. Since the drying material and the sorbent material absorb a lot of water vapor during a longer downtime and high relative humidity, it may be necessary to first dry the drying agent and/or the sorbent material before the system can be switched to normal operation.

In some embodiments, a temperature in one of the process spaces and/or a pressure in one of the process spaces is changed compared to normal operation in order to regenerate the drying agent and/or dry the sorbent material. The drying process may be improved by lowering the pressure and/or raising the temperature, which can facilitate the regeneration of the drying agent and/or the drying of the sorbent material. It is also possible to support the drying by introducing a purge gas in some embodiments. Air that is as dry as possible and already present at some point in the system is suitable as purge gas, for example from a parallel system that is already running in normal operation. Alternatively, or for initialization, purge gas from a storage tank can be used according to some embodiments. Both dried air from a storage tank and nitrogen, in particular from a pressurized storage tank such as a pressurized cylinder or cylinder bundle, can be used here.

In some embodiments, it is provided that the special operation comprises switching off or shutting down the system. When the system is switched off, it can be preconditioned in such a way that, in subsequent operation, starting up the system and subsequent normal operation are facilitated. This can shorten the process time during start-up.

In some embodiments, the first process space and/or the second process space, or for example both process spaces, are closed in a gas-tight manner when the system is switched off or shut down. This prevents moist air from flowing into the process spaces and moisture from collecting in the drying material and/or sorbent material. This eliminates the need for an additional drying process during the subsequent start-up of the system or at least shortens such a drying process.

Alternatively or additionally and in some embodiments, it is provided that the first process space and/or the second process space, or for example both process spaces, are subjected to an overpressure when the system is switched off or shut down in order to prevent moist ambient air from flowing into one of the process spaces. By generating an overpressure in one of the process spaces or both process spaces, the inflow of moist ambient air is efficiently prevented, since in the event of a gas leak, the pressurized air first flows out of the respective process space. This prevents moist air from flowing into the process spaces and moisture from collecting in the drying material and/or sorbent material. This eliminates the need for an additional drying process during the subsequent start-up of the system or at least shortens such a drying process.

In some embodiments, it is provided that the special operation comprises a downtime mode of the system. A downtime mode is to be understood as a time-limited operating mode in which the system is not completely switched off, but no ambient air is being dried and/or no carbon dioxide is being separated. In particular, such a downtime mode can comprise the at least one conveying element for conveying a stream of ambient air through the system being switched off.

In some embodiments, the first process space and/or the second process space, or for example both process spaces, are closed in a gas-tight manner in downtime mode. This prevents moist air from flowing into the process spaces and moisture from collecting in the drying material and/or sorbent material. This eliminates the need for an additional drying process during the subsequent start-up of the system or at least shortens such a drying process.

Alternatively or additionally and in some embodiments, it is provided that a stream of air circulates during the downtime mode in at least one of the process spaces, or for example in both process spaces, in order to prevent fresh air from flowing into the process space. Alternatively, the stream of air may also circulate through both process spaces in downtime mode, so that a circulated stream of air is passed through both the first process space and then through the second process space. By circulating the ambient air located in the process spaces, which can also be referred to as air circulation operation, there is no gas exchange from the respective process space. This may prevent or, respectively, reduce the inflow of moist air, the moisture of which is stored in the drying agent and/or the sorbent material.

Alternatively or additionally and in some embodiments,, it is provided that the first process space and/or the second process space are subjected to an overpressure when the system is in downtime mode in order to prevent moist ambient air from flowing into one of the process spaces. By generating an overpressure in one of the process spaces or both process spaces, the inflow of moist ambient air is efficiently prevented, since in the event of a gas leak, the pressurized air first flows out of the respective process space. This prevents moist air from flowing into the process spaces and moisture from collecting in the drying material and/or sorbent material. The overpressure can be produced in particular by an additional gas storage tank, in which dry air or nitrogen is stored in order to prevent moist ambient air from entering one of the process spaces. This reduces the need for an additional drying process during subsequent normal operation of the system or at least shortens such a drying process.

In some embodiments, it is provided that the special operation comprises an adjustment of the system parameters following a detected malfunction of the system. A malfunction of the system usually means that normal operation of the system must be interrupted. Even in the event of such a malfunction, it is helpful to close at least one of the process spaces in a gas-tight manner, let air circulate in one of the process spaces or both process spaces and/or build up a corresponding overpressure in the process space to prevent the ingress of moist ambient air and to keep the drying agent and the sorbent material as dry as possible in order to be able to switch back to normal operation as quickly as possible once the malfunction has been rectified.

Some embodiments relate to a system for separating carbon dioxide from the ambient air, which has a dryer, also referred to as ‘drying unit’ herein, for drying the ambient air, at least one conveyor, also referred to herein as a ‘conveying element’, in particular at least one blower for conveying a stream of ambient air into a first process space in the dryer. The stream of air or, respectively, the ambient air is dried in this first process space. The system also comprises a sorption unit, also referred to herein as a ‘sorption enclosure’, for adsorbing carbon dioxide from the dried stream of air with a sorbent material in a second process space and for subsequent desorption of the carbon dioxide adsorbed in the sorbent material. The system also has storage, also referred to herein as a ‘storage unit’, in which the separated carbon dioxide is stored after desorption. Furthermore, the system has a processor, wherein the processor is configured to execute a method described herein. It is noted that the terms ‘processor’ and ‘control unit’ are used interchangeably herein.

The system may make it possible to achieve efficient preconditioning of the process spaces of the system during special operation, in particular to minimize water retention in the drying agent and/or the sorbent. The system also enables efficiency to be increased in normal operation following special operation, since the conditions in the process spaces are already favorable for drying the air or, respectively, adsorbing carbon dioxide.

In some embodiments, it is provided that a humidity sensor and/or a temperature sensor is arranged in the dryer or downstream of the dryer and upstream of the sorption unit. The regeneration of the drying material can be controlled by determining the humidity and/or temperature in the dryer, in particular in the first process space. Furthermore, by recording the humidity and temperature in special operation, it is possible to determine when the system can be switched from special operation to normal operation.

In some embodiments, it is provided that a temperature sensor, a pressure sensor, a humidity sensor, a sensor for detecting the carbon dioxide concentration, a sensor for detecting the flow velocity and/or a mass flow sensor and/or a volume flow sensor are arranged in the sorption unit. The adsorption or, respectively, desorption can be optimized by detecting a temperature, a pressure, a humidity, a carbon dioxide concentration and/or a flow velocity through the second process space. Furthermore, the closure elements can be controlled by detecting the pressure in order to prevent unwanted ambient air from flowing into the sorption unit during special operation of the system. Furthermore, the detection of other process variables such as humidity or carbon dioxide concentration downstream of the sorbent enables drying of the sorbent material to be initiated before new ambient air is introduced into the sorption unit in order to enable efficient separation of carbon dioxide.

In the embodiments described herein, the described components of the embodiments each represent individual features that are to be considered independent of one another, in the combination as shown or described, and in combinations other than shown or described. In addition, the described embodiments can also be supplemented by features other than those described.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

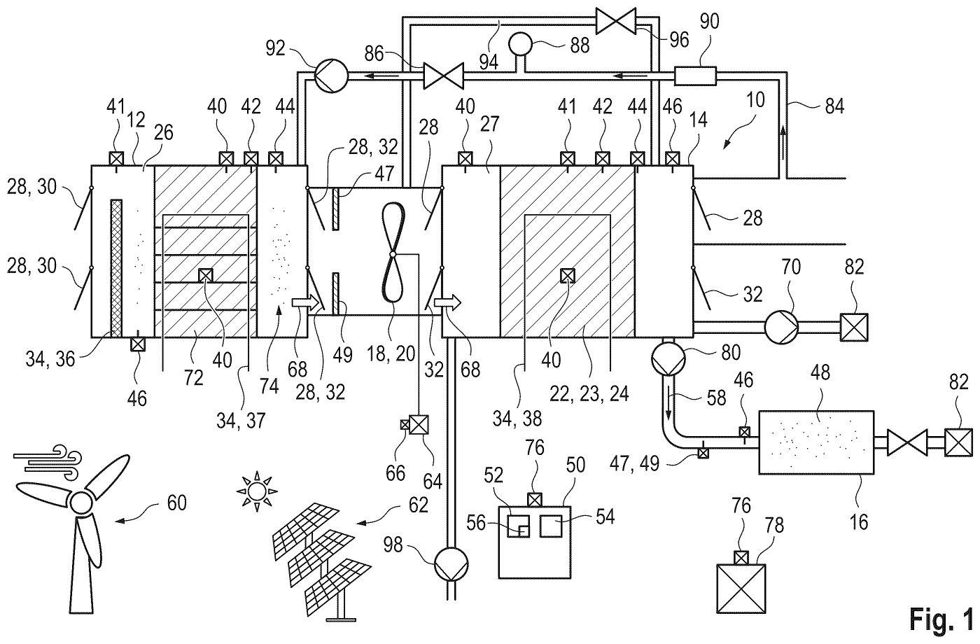

FIG. 1 shows a system 10 for separating carbon dioxide 48 from the ambient air 74. Ambient air is fed to the system 10 and carbon dioxide 48 and water are extracted from this ambient air 74. A stream of exhaust air, which has dry, carbon-dioxide-reduced air compared to the incoming air, flows out of the system 10. The system 10 comprises a drying unit 12, in which the humidity contained in the ambient air is at least partially extracted from the stream of air 68. For example, a hydrophilic material such as silica gel can be used as the drying agent 72 for the drying unit 12. In principle, any drying agent 72 that is suitable for absorbing moisture from the air can be used as the drying material. In particular, a sorbent material 22, in particular a physisorbent 23, can also be provided in the drying unit 12 as a drying agent 72. For example, a drying agent 72 such as silica gel is used which can be regenerated and fed back into the process by means of appropriate process control after the humidity has been absorbed. The aim is to achieve a degree of drying of the ambient air at which the residual moisture in the air has a dew point of at most −30° C., or for example −50° C., or for example at most a dew point of −60° C. The system 10 further comprises a sorption unit 14, in which the carbon dioxide 48 from the ambient air 74 is bound. The carbon dioxide 48 in the dried ambient air 74 is stored in a sorbent material 22, in particular in a physisorbent 23, for example in a zeolite material 24.

In addition, the system 10 has a storage unit 16 in which the carbon dioxide 48 separated from the ambient air in the sorption unit 14 is stored in concentrated form. Alternatively or in addition to a storage unit 16, the separated carbon dioxide 48 can also be fed to a process and/or a consumer 82 in which the carbon dioxide is further processed or utilized. The system 10 further comprises a conveying element 18, in particular a blower 20, with which a stream of air is passed through the drying unit 12 and then through the sorption unit 14 to the ambient air.

The ambient air 74 is for example dried in a first process space 26, which can be separated from the environment in a substantially gas-tight manner by closure elements 28, in particular by flaps 30, 32. The first process space 26 has at least one inlet flap 30 and one outlet flap 32. In the exemplary embodiment shown in FIG. 1, the first process space 26 has two inlet flaps 30 and two outlet flaps 32. A heating element 34 and/or a cooling element 36 can be arranged in the first process space 26 in order to manipulate the air temperature in the drying unit 12 or, respectively, in the first process space 26. For example, a heating element 34 and/or a cooling element 36 or, respectively, a combined heating/cooling element 37 is provided, with which the drying agent 72 is tempered. A temperature sensor 40, a pressure sensor 41, a humidity sensor 42, a sensor 46 for detecting the flow velocity, a mass flow sensor and/or a volume flow sensor 49 are arranged in the first process space 26 or, respectively, in the drying unit 12. For example, a temperature sensor 40 is provided in the drying material 72 to determine the temperature of the drying material 72.

The adsorption and subsequent desorption of carbon dioxide for example takes place in a second process space 27, which can be separated from the environment in a substantially gas-tight manner by means of closure elements 28, in particular by flaps 30, 32. Furthermore, the second process space 27 has a heating element 34, in particular a heat exchanger 38, in order to be able to raise the temperature accordingly, in particular during the desorption process, and to release the carbon dioxide 48 adsorbed in the sorption material 22. A vacuum pump 70 can be provided at the second process space 27 or, respectively, at the sorption unit 14 in order to manipulate the air pressure in the second process space 27 and, in particular, to lower it during a desorption process. The second process space 27 is fluidically connected to the storage unit 16, in which the carbon dioxide 48 separated from the ambient air can be stored. A compressor 80 is provided for this purpose, which conveys the carbon dioxide 48 released during desorption in the second process space 27 into the storage unit 16 and compresses it there. Alternatively or additionally, a further vacuum pump 70 can also be arranged in the connection from the second process space 27 to the storage unit 16 in order to suction the carbon dioxide 48 from the second process space 27 and feed it to the storage unit 16. A temperature sensor 40, a pressure sensor 41, a humidity sensor 42, a sensor for detecting the carbon dioxide concentration, a sensor 46 for detecting the flow velocity, and/or a mass flow sensor and/or a volume flow sensor 49 are arranged in the second process space 27 or, respectively, or in the adsorption unit 14.

A conveying element 18, in particular a blower 20, is provided between the drying unit 12 and the sorption unit 14 in order to convey a stream of air 68 of the ambient air first through the drying unit 12 and then through the sorption unit 14. The conveying element 18 has a drive unit 64, the power of which can be adjusted accordingly via a power control 66.

The system 10 is for example supplied with electricity from renewable energies such as wind power, geothermal energy or solar energy, so as not to generate any additional carbon dioxide emissions during operation. For this purpose, a wind turbine 60 and/or a solar system 62, in particular a photovoltaic system, is provided in order to supply the system 10 with renewable energy.

The system 10 may additionally have a return line 84 that returns dried, low-carbon dioxide air downstream from the second process space 27 or downstream of the second process space 27 to the first process space 26. A return valve 86 is provided in the return line 84, via which a volume flow of returned, dried and carbon-dioxide-reduced air can be set. Furthermore, a storage tank 88 can be provided on the return line 84 in order to store the dried, carbon-dioxide-reduced air and, in particular, to release it again during downtime of the system 10 in order to set an overpressure in at least one of the process spaces 26, 27. Furthermore, a non-return valve 90 is arranged in the return line 84 in order to prevent a bypass around the second process space 27 and to specify a flow direction through the return line 84. In addition, a blower 92 can be integrated into the return line 84 to convey the return air.

The system 10 can also have a purge gas line 94, which suctions dried air downstream of the drying unit 12 and, flowing through the sorption material 22, transports away any residual moisture that escapes. A purge gas control valve 96 and a purge gas pump 98 can be integrated in the purge gas line 94 to control the purge gas flow. The function of the vacuum pump 70, the compressor 80 and the purge gas pump 98 can also be realized in one or two pumps.

The system 10 also has a control unit 50 with a storage unit 52 and a computing unit 54, wherein a computer program code 56 is saved in the storage unit 52 and is configured, when executed by the computing unit 54 of the control unit 50, to control the operation of the system 10 for separating carbon dioxide 48 from the ambient air 74. The control unit 50 can be connected to a data center 78 via a data connection 76, which data center provides the system 10 with data for controlling the system 10 or exchanges data with it.

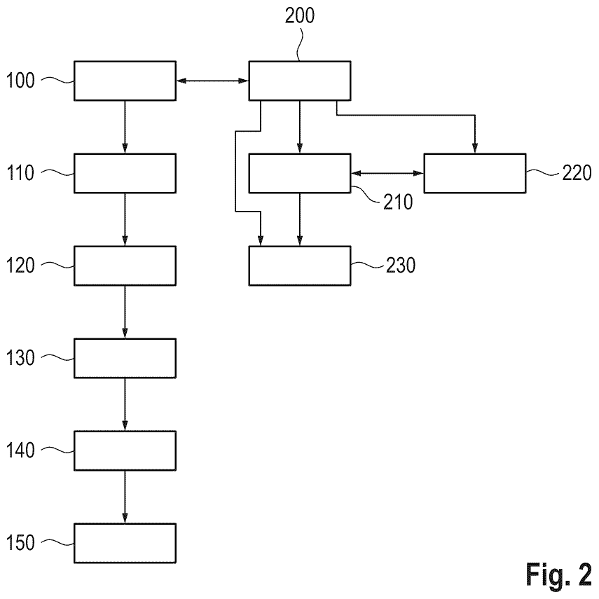

FIG. 2 shows a flow chart for carrying out a method according to the teachings herein for controlling a system 10 for separating carbon dioxide 48 from the ambient air 74. The method distinguishes between normal operation 100, in which carbon dioxide 48 is separated from the ambient air 78, and special operation 200, which is not primarily used for separating carbon dioxide 48, but mainly for preconditioning the system 10 for the next normal operation 100. In normal operation, in a method step 110, a stream of air 68 of the ambient air 74 is conveyed into a first process space 26 of the system, which is located in the drying unit 12. In this first process space 26, the stream of air 68 is dried, wherein moisture is extracted from the stream of air 68 and stored in a drying agent 72.

After drying, the dried ambient air 74 is conducted from the first process space 26 to a second process space 27 in a process step 120. The conduction is carried out by a conveying element 18, in particular by a blower 20, which conveys the stream of air 68 of the dried ambient air 68 from the first process space 26 of the drying unit into the second process space 27 of the sorption unit 14. The drying agent 72 is regenerated when the drying agent 72 is largely loaded with water vapor and the drying performance diminishes. For this purpose, the drying agent 72 is freed of the stored water vapor in order to be available for a new drying cycle of ambient air.

In a method step 130, the carbon dioxide 48 from the stream of air 68 dried in the first process space 26 is sorbed in the sorbent material 22 in the second process space 27 of the system 10, which is located in the sorption unit 14.

In a method step 140, the carbon dioxide 48 adsorbed in the sorbent material 22 is desorbed. For this purpose, the second process space 27 is closed in a gas-tight manner to prevent further ambient air 68 from flowing in. Furthermore, the pressure in the second process space 27 is lowered and the second process space 27 is heated to a desorption temperature.

In a method step 150, the carbon dioxide 48 released during desorption is fed to a storage unit 16 and stored there. Alternatively, the carbon dioxide is fed directly or from the storage unit 16 to a use where it is further processed or utilized. The sorbent material 22 can then be dried in order to free the sorbent material 22 of any remaining moisture and to increase the absorption capacity for carbon dioxide 48.

In special operation 200 of the system 10, it is operated in a special operating mode that deviates from the operating mode of normal operation 100. Special operation 200 means in particular, but not exhaustively, a start-up of the system 10 after a downtime period or installation, a shutdown or switch-off of the system 10, a partial load operation of the system, a downtime mode of the system or an operation of the system 10 after a malfunction has been detected, or a special drying step of the sorbents.

In such a special operation 200, measures are initiated in order to be able to react in the best possible way to the special features of the corresponding operating situation depending on the situation and, in particular, to precondition the system 10 for subsequent normal operation 100.

When the system 10 is started up after a longer downtime period, in particular a downtime period of more than 24 hours, a drying mode is initially provided in order to dry the drying agent 72 in the first process space 26 and the sorbent material 22 in the second process space 27.

When the system 10 is shut down, it is provided that the first process space 26 and the second process space 27 are preconditioned in such a way that an outflow of moist ambient air into one of the process spaces 26, 27 is prevented or at least reduced. This can be achieved, among other things, by closing the process spaces 26, 27 in a gas-tight manner in a method step 210.

Furthermore, in a process step 220, an overpressure can be built up in one of the process spaces 26, 27 in order to prevent moist ambient air from flowing in. As an alternative to an overpressure, the system can also be operated in air circulation mode, wherein the already dried ambient air is circulated in order to prevent new ambient air 74 from flowing in.

In a method step 230, the drying agent 72 and/or the sorbent material 22 are dried or, respectively, regenerated by operating the system 10 with special operating parameters. In particular, a pressure and/or a temperature in the process space 26, 27 can be adjusted to support the drying of the drying agent 72 and/or the sorbent material 22. Another means of controlling this process step is the duration.

If the special operation relates to a downtime mode of the system 10, in which the system 10 is only taken out of normal operation for a short time and is not completely switched off, the system 10 is closed in a method step 210. An air inlet into the first process space 26 or, respectively, into the drying unit 12 and an air outlet out of the second process space 27 or, respectively, the sorption unit 14 are closed, so that the air located in the system 10 circulates through the system 10 in one method step 220 in air circulation operation. Alternatively or additionally, an overpressure can be built up by the conveying element 18 in order to prevent excess moist ambient air from flowing in even if the system is not closed in a completely gas-tight manner. These measures mean that the drying agent 72 and the sorbent material 22 do not absorb any additional moisture, so that the system 10 can be returned to normal operation comparatively quickly after the downtime mode has ended.

### LIST OF REFERENCE NUMERALS

10 System for separating carbon dioxide
12 Dryer (Drying unit)
14 Sorption unit (Sorption enclosure)
16 Storage (Storage unit)
18 Conveyor (Conveying element)
20 Blower
22 Sorbent material
23 Physisorbent
24 Zeolite
26 First process space
27 Second process space
28 Closure element
30 Inlet flap
32 Outlet flap
34 Heating element (Heater)
36 Cooling element (Cooler)
37 Combined heating/cooling element
38 Heat exchanger
40 Temperature sensor
41 Pressure sensor
42 Humidity sensor
44 Sensor for detecting the carbon dioxide concentration
46 Sensor for detecting the flow velocity
47 Mass flow sensor
48 Carbon dioxide
49 Volume flow sensor
50 Processor (Control apparatus)
52 Storage unit
54 Computer (Computing unit)
56 Computer program code
58 Product gas stream
60 Wind turbine
62 Solar system
64 Drive unit
66 Power control
68 Stream of air
70 Vacuum pump
72 Drying agent
74 Ambient air
76 Data connection
78 Data source
80 Compressor
82 Consumer
84 Return line
86 Return valve
88 Storage tank
90 Non-return valve
92 Blower for return air
94 Purge gas line
96 Purge gas control valve
98 Purge gas pump
100 Method step—Operating the system in normal operation
110 Method step—Conveying a stream of air into a drying unit
120 Method step—Conducting dried ambient air
130 Method step—Adsorbing carbon dioxide
140 Method step—Desorbing carbon dioxide
150 Method step—Storing the desorbed carbon dioxide
200 Method step—Operating the system in special operation
210 Method step—Closing a process space
220 Method step—Generating overpressure in one of the process spaces
230 Method step—Regenerating or drying sorbent material

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method of controlling a system for separating carbon dioxide from the ambient air, comprising:
operating the system in normal operation, wherein normal operation comprises:
conveying a stream of air of the ambient air into a first process space, wherein the stream of air is dried in the first process space;
conducting the dried ambient air from the first process space to a second process space;
adsorbing carbon dioxide from the dried stream of air with a sorbent material in the second process space;
desorbing the carbon dioxide adsorbed in the sorbent material; and
storing the desorbed carbon dioxide in a storage or conducting the desorbed carbon dioxide for direct use in a subsequent process; wherein
the method further comprises operating the system in a special operation mode, different from normal operation, which special operation mode takes place before or after normal operation, wherein the system is operated in the special operation mode with operating parameters deviating from normal operation.

2. The method of claim 1, wherein the special operation mode is a start-up of the system after a system downtime.

3. The method of claim 2, wherein an additional regeneration of drying agent and/or a drying of the sorbent material takes place during the start-up of the system before the stream of air of the ambient air is introduced into a dryer or a sorption unit of the system.

4. The method of claim 3, wherein a temperature in one of the process spaces and/or a pressure in one of the process spaces, or the process step duration is changed compared to normal operation in order to regenerate the drying agent and/or for drying the sorbent material.

5. The method of claim 1, wherein the special operation mode comprises switching off or shutting down the system.

6. The method of claim 5, wherein the first process space and/or the second process space are closed in a gas-tight manner when the system is switched off or shut down.

7. The method of claim 5, wherein the first process space and/or the second process space are subjected to an overpressure when the system is switched off or shut down, in order to prevent moist ambient air from flowing into one of the process spaces.

8. The method of claim 1, wherein the special operation mode comprises a downtime mode of the system.

9. The method of claim 8, wherein the first process space and/or the second process space are closed in a gas-tight manner when the system is in downtime mode.

10. The method of claim 8, wherein a stream of air of the ambient air circulates in one of the process spaces.

11. The method of claim 8, wherein the first process space and/or the second process space are subjected to an overpressure when the system is in downtime mode, in order to prevent moist ambient air from flowing into one of the process spaces.

12. The method of claim 1, wherein the special operation mode comprises an adjustment of the system parameters after a detected malfunction of the system.

13. A system for separating carbon dioxide from the ambient air, comprising:
a dryer for drying the ambient air;
a conveyor for conveying a stream of air of the ambient air into a first process space in the dryer, wherein the stream of air is dried in the first process space;
a sorption unit for adsorbing carbon dioxide from the dried stream of air with a sorbent material in a second process space, and for subsequently desorbing the carbon dioxide adsorbed in the sorbent material;
a storage for storing the desorbed carbon dioxide or a process unit for using or further processing the separated carbon dioxide; and
a processor, wherein the processor is configured to execute the method of claim 1.

14. The system of claim 13, wherein a humidity sensor/dew point sensor and/or a temperature sensor is arranged in the dryer or downstream of the dryer and upstream of the sorption unit.

15. The system of claim 13, wherein a temperature sensor, a pressure sensor, a humidity sensor, a sensor for detecting the carbon dioxide concentration, a sensor for detecting the flow velocity, a mass flow sensor and/or a volume flow sensor is arranged in the sorption unit.

16. The system of claim 13, wherein the special operation mode is a start-up of the system after a system downtime.

17. The system of claim 13, wherein an additional regeneration of drying agent and/or a drying of the sorbent material takes place during the start-up of the system before the stream of air of the ambient air is introduced into a dryer or a sorption unit of the system.

18. The system of claim 13, wherein a temperature in one of the process spaces and/or a pressure in one of the process spaces, or the process step duration is changed compared to normal operation in order to regenerate the drying agent and/or for drying the sorbent material.

19. The system of claim 13, wherein the special operation mode comprises switching off or shutting down the system.

20. The system of claim 19, wherein the first process space and/or the second process space are closed in a gas-tight manner when the system is switched off or shut down.
